(19) United States
(12) Patent Application Publication
(10) Pub. No.: US 2011/0157349 A1
(43) Pub. Date: Jun. 30, 2011

(54) STAGE CONTROL DEVICE, STAGE CONTROL METHOD, STAGE CONTROL PROGRAM, AND MICROSCOPE

(75) Inventors: Takashi Yamamoto, Tokyo (JP); Koichiro Kishima, Kanagawa (JP); Ryu Narusawa, Kanagawa (JP); Yu Hirono, Tokyo (JP); Fumiyasu Suzuki, Saitama (JP)

(73) Assignee: SONY CORPORATION, Tokyo (JP)

(21) Appl. No.: 12/972,030

(22) Filed: Dec. 17, 2010

(30) Foreign Application Priority Data
Dec. 25, 2009 (JP) P2009-295382
Jun. 28, 2010 (JP) P2010-146745

(51) Int. Cl. H04N 7/18; H04N 5/225

(52) U.S. Cl. 348/79; 348/373; 348/E07.085; 348/E05.024

(57) ABSTRACT

A stage control device is provided and includes: an obtaining section obtaining a set of images as different visual points in all or a part of a sample set as a photographing object; a distance calculating section calculating a distance between each pixel of one image to be set as a reference in the set of images and a relative pixel in the other image; a tilt angle calculating section calculating a tilt angle of the sample using the distance calculated by the distance calculating section; and an adjusting section adjusting a tilt angle of a stage surface on which the sample is disposed so as to minimize a tilt within an angle of view of a photographed picture on a basis of the tilt angle of the sample.

### CROSS REFERENCES TO RELATED APPLICATIONS

The present application claims priority to Japanese Patent Application JP 2009-295382 filed on Dec. 25, 2009 and Japanese Patent Application JP 2010-146745 filed on Jun. 28, 2010, the entire contents of which are hereby incorporated by reference.

### BACKGROUND

The present disclosure relates to a stage control device, a stage control method, a stage control program, and a microscope, and is suitable for observing a tissue section, for example.

In pathological examination, a tissue section is fixed to a glass slide, subjected to a staining process and an enclosure process, and prepared as a preparation. In general, when the preparation is stored for a long period of time, the visibility of the preparation under a microscope is degraded due to degradation of the living body sample, color fading, and the like. In addition, the preparation may be microscopically examined in facilities other than facilities such for example as a hospital that prepared the preparation, and the preparation is generally sent and received by mail, which requires a certain time.

In view of such an actual situation and the like, a device storing a living body sample as image data is proposed (see Japanese Patent Laid-Open No. 2009-175334, for example). This device uses a focusing technique for focusing on a living body sample on the basis of the contrast of a picked-up image.

### SUMMARY

A living body sample has a thickness. When images of the entire region in a direction of thickness (direction of depth) of the living body sample are to be picked up, the number of picked-up images depends on a depth of field of an objective lens.

For example, when the thickness of the living body sample in a preparation is 100 [μm], and the depth of field of the objective lens is 1 [μm], at least 100 picked-up images need to be obtained.

The number of picked-up images is reduced as the depth of field is increased. However, this is not desirable because the picked-up images are increased in degree of blurring and thus degraded in quality.

The present embodiment has been made in view of the above points. It is desirable to propose a stage control device, a stage control method, a stage control program, and a microscope that can improve efficiency of obtainment of images of a sample without changing the depth of field.

According to an embodiment, there is provided a stage control device including: obtaining means for obtaining a set of images as different visual points in all or a part of a sample set as a photographing object; distance calculating means for calculating a distance between each pixel of one image to be set as a reference in the set of images and a relative pixel in the other image; tilt angle calculating means for calculating a tilt angle of the sample using the distance calculated by the distance calculating means; and adjusting means for adjusting a tilt angle of a stage surface on which the sample is disposed so as to minimize a tilt within an angle of view of a photographed picture on a basis of the tilt angle of the sample.

According to an embodiment, there is provided a stage control method including: an obtaining step of obtaining a set of images as different visual points in all or a part of a sample set as a photographing object; a distance calculating step of calculating a distance between each pixel of one image to be set as a reference in the set of images and a relative pixel in the other image; a tilt angle calculating step of calculating a tilt angle of the sample using the distance calculated in the distance calculating step; and an adjusting step of adjusting a tilt angle of a stage surface on which the sample is disposed so as to minimize a tilt within an angle of view of a photographed picture on a basis of the tilt angle of the sample.

According to an embodiment, there is provided a stage control program for making a computer perform the steps of: obtaining a set of images as different visual points in all or a part of a sample set as a photographing object; calculating a distance between each pixel of one image to be set as a reference in the set of images and a relative pixel in the other image; calculating a tilt angle of the sample using the calculated distance; and adjusting a tilt angle of a stage surface on which the sample is disposed so as to minimize a tilt within an angle of view of a photographed picture on a basis of the tilt angle of the sample.

In addition, according to an embodiment, there is provided a microscope including: a stage having a surface on which a sample is disposed, the stage being movable in a direction parallel to the surface and a direction orthogonal to the surface, and the stage being capable of changing a tilt angle of the surface; an objective lens for forming an image of a part of the sample disposed on the surface; an optical system for forming a set of images as different visual points using the image formed in the objective lens; distance calculating means for calculating a distance between each pixel of one image to be set as a reference in the set of images formed by the optical system and a relative pixel in the other image; tilt angle calculating means for calculating a tilt angle of the sample using the distance calculated by the distance calculating means; and adjusting means for adjusting a tilt angle of the stage surface on which the sample is disposed so as to minimize a tilt within an angle of view of a photographed picture on a basis of the tilt angle of the sample.

The embodiments can maintain the number of photographs in a direction of thickness (direction of depth) of a sample set as a photographing object at substantially the same level even when the sample is in a tilted state or a preparation itself to which the sample is fixed is in a tilted state.

Therefore, the embodiments can greatly reduce the number of photographs in the direction of thickness of the sample as compared with a case of photographing the sample remaining in a tilted state. In addition to this, the embodiments can greatly reduce a load in a process of searching for an in-focus position as compared with a case of searching for the in-focus position with the sample remaining in a tilted state.

Thus, a stage control device, a stage control method, a stage control program, and a microscope that can improve efficiency of obtainment of images of a sample without changing a depth of field are each realized.

Additional features and advantages are described herein, and will be apparent from the following Detailed Description and the figures.

### BRIEF DESCRIPTION OF THE FIGURES

FIG. 1 is a schematic diagram showing a constitution of a microscope;

FIG. 2 is a photograph showing a photographing object image and phase difference images of a tissue section;

FIG. 3 is a schematic diagram showing an example of driving constitution of a preparation stage;

FIGS. 4A and 4B are schematic diagrams showing a tilted state of a preparation disposition surface;

FIG. 5 is a schematic diagram showing a functional configuration of a stage control section;

FIG. 6 is a schematic diagram showing a depression and projection state of a tissue section;

FIG. 7 is a schematic diagram showing a parallax of each pixel of one image with respect to another image of phase difference images;

FIG. 8 is a schematic diagram of assistance in explaining a straight line most closely approximating the parallax (depression and projection distribution) of each pixel in an X-Z direction;

FIGS. 9A and 9B are schematic diagrams of assistance in explaining adjustment of tilts in a long side direction and a short side direction on the preparation disposition surface;

FIG. 10 is a flowchart of a tilt angle adjusting process procedure;

FIGS. 11A and 11B are schematic diagrams of assistance in explaining limitation of parts where phase difference images are obtained;

FIG. 12 is a schematic diagram of assistance in explaining limitation of parts where phase difference images are obtained;

FIG. 13 is a schematic diagram of assistance in explaining a parameter (1) related to a condition for determining whether to adjust a tilt angle or not; and

FIG. 14 is a schematic diagram of assistance in explaining a parameter (2) related to a condition for determining whether to adjust a tilt angle or not.

### DETAILED DESCRIPTION

Embodiments will hereinafter be described. Incidentally, description will be made in the following order.

<1. Embodiment>

[1-1. Constitution of Microscope]

[1-2. Preparation Stage Driving Constitution]

[1-3. Functional Constitution of Stage Driving Control Section]

[1-4. Tilt Angle Adjusting Process Procedure]

[1-5. Effects and Others]

<2. Other Embodiments>

### 1. Embodiment

### 1-1. Constitution of Microscope

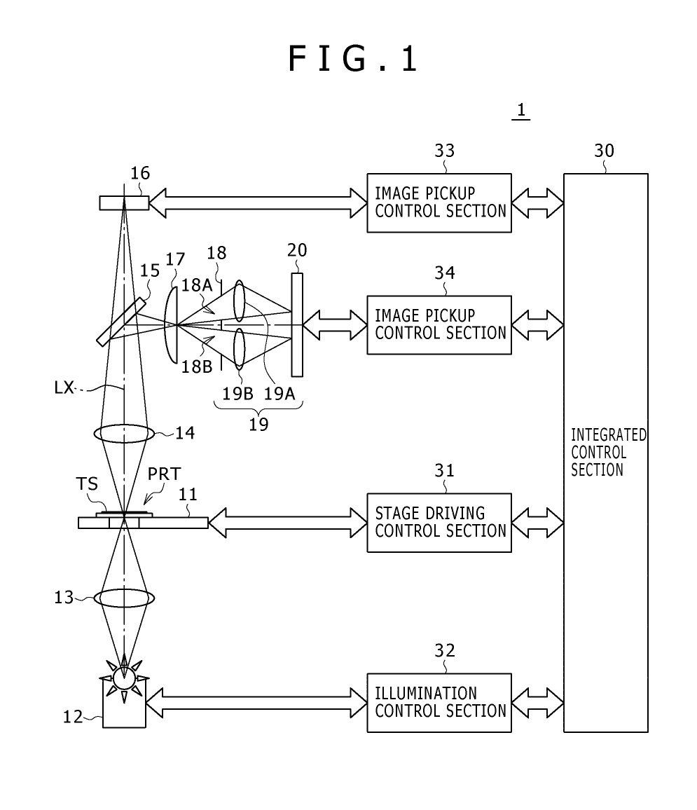

FIG. 1 shows a constitution of a microscope 1 according to an embodiment. The microscope 1 has a stage 11 on which a preparation PRT can be disposed (which stage will hereinafter be referred to also as a preparation stage).

The preparation PRT is prepared by fixing a section of a tissue such as a connective tissue of blood or the like, an epithelial tissue, both tissues or the like to a glass slide SG by a predetermined fixing method. The tissue section is stained as required. Staining includes not only staining referred to as general staining typified by HE (hematoxylin and eosin) staining, Giemsa staining, Papanicolaou staining or the like but also staining referred to as special staining such as FISH (Fluorescence In-Situ Hybridization), an enzyme antibody technique or the like.

A light source 12 is disposed on an opposite surface side of the preparation stage 11 from a surface on which the preparation PRT is disposed (which surface will be referred to also as a preparation disposition surface). The light source 12 can select and apply light for illuminating a tissue section that has undergone general staining (which light will hereinafter be referred to also as bright field illumination light) or light for illuminating a tissue section that has undergone special staining (which light will hereinafter be referred to also as dark field illumination light). However, a light source 12 capable of applying bright field illumination light or dark field illumination light may be applied.

A condenser lens 13 having a normal of a reference position on the preparation disposition surface as an optical axis is disposed between the preparation stage 11 and the light source 12.

An objective lens 14 having the normal of the reference position on the preparation disposition surface as an optical axis is disposed on the side of the preparation disposition surface of the preparation stage 11. This objective lens 14 is selected from a plurality of objective lenses of different magnifications by a lens selecting mechanism through an electric operation or a manual operation.

A half mirror 15 is disposed in the rear of the objective lens 14. The half mirror 15 divides light incident from the objective lens 14 into transmitted light and reflected light. An image pickup element 16 having a surface on which a subject image of the objective lens 14 is formed as an image pickup surface is disposed in the rear of a transmission side of the half mirror 15.

On the other hand, a field lens 17 is disposed in the rear of a reflection side of the half mirror 15. The field lens 17 relays the subject image of the objective lens 14 which image is projected onto the reflection side of the half mirror 15 to the rear (intended image forming surface). The field lens 17 condenses the subject light reflected by the half mirror 15, and therefore suppresses a decrease in brightness on the periphery of a field of view.

A diaphragm mask 18 is disposed in the rear of the field lens 17. The diaphragm mask 18 has a pair of apertures 18A and 18B at symmetric positions of a surface orthogonal to the optical axis of the field lens 17 with the optical axis of the field lens 17 as a boundary. The diaphragm mask 18 divides a subject luminous flux incident from the field lens 17 by the apertures 18A and 18B. The divided luminous fluxes intersect each other at the image forming surface of the subject luminous flux, and positional relation between the luminous fluxes in front of the image forming surface and positional relation between the luminous fluxes in the rear of the image forming surface are interchanged.

Separator lenses 19A and 19B are disposed in the rear of the pair of apertures 18A and 18B, respectively. The separator lenses 19A and 19B subject the divided luminous fluxes divided by the corresponding apertures 18A and 18B to tilt image formation (shift), and thereby form two subject images of different visual points (which images will hereinafter be referred to also as phase difference images) on the intended image forming surface relayed by the field lens 17.

Incidentally, when the separator lenses 19A and 19B are affected by vignetting (shading) of the field lens 17, part of the divided luminous fluxes are lost. The separator lenses 19A and 19B are therefore arranged close to the central side of the field lens 17 so as not to be affected by the vignetting. In addition, the depth of field of the separator lenses 19A and 19B is set wider than the depth of field of the objective lens 14. The depth of field of the separator lenses 19A and 19B is set by a process of setting an aperture adjusting section for changing the size of the apertures 18A and 18B in the diaphragm mask 18.

An image pickup element 20 is disposed in the rear of the separator lenses 19A and 19B. This image pickup element 20 is not a line sensor but an area sensor. That is, the image pickup element 20 is disposed with a surface on which the phase difference images of the subject appearing in the objective lens 14 are formed as an image pickup surface.

A stage driving control section 31, an illumination control section 32, and image pickup control sections 33 and 34 are provided as a control system in the microscope 1. These control sections are a computer including a CPU (Central Processing Unit), a ROM (Read Only Memory), a RAM (Random Access Memory) serving as a work memory for the CPU, arithmetic circuitry and the like.

The stage driving control section 31 moves (scans) the preparation stage 11 in a direction parallel to the preparation disposition surface so that the tissue section TS of the preparation PRT is allocated to a condensed light part where light is condensed by the condenser lens 13.

The stage driving control section 31 also moves the preparation stage 11 in a direction orthogonal to the preparation disposition surface (that is, a direction of thickness of the tissue section) so that the objective lens 14 is focused on a part of the tissue section TS allocated to the condensed light part.

The illumination control section 32 sets a parameter corresponding to a mode in which to obtain a bright field image (which mode will hereinafter be referred to also as a bright field mode) or a mode in which to obtain a dark field image (which mode will hereinafter be referred to also as a dark field mode) in the light source 12, and makes illumination light applied from the light source 12. This parameter is for example the intensity of the illumination light and a selection of a kind of light source.

Incidentally, the illumination light in the bright field mode is generally visible light. On the other hand, the illumination light in the dark field mode is light including a wavelength for exciting a fluorescent marker used in special staining. In addition, a background part with respect to the fluorescent marker is cut out in the dark field mode.

When the illumination light is applied from the light source 12, the illumination light is condensed to a reference position of the preparation disposition surface on the preparation stage 11 by the condenser lens 13. An image of the condensed light part where the light is condensed by the condenser lens 13 in the tissue section TS in the preparation PRT is magnified and formed on the image forming surface of the objective lens 14, and the magnified image is formed as a subject image on the image pickup surface of the image pickup element 16. In addition, the subject image reflected by the half mirror 15 is formed as phase difference images on the image pickup surface of the image pickup element 20 by the separator lenses 19A and 19B.

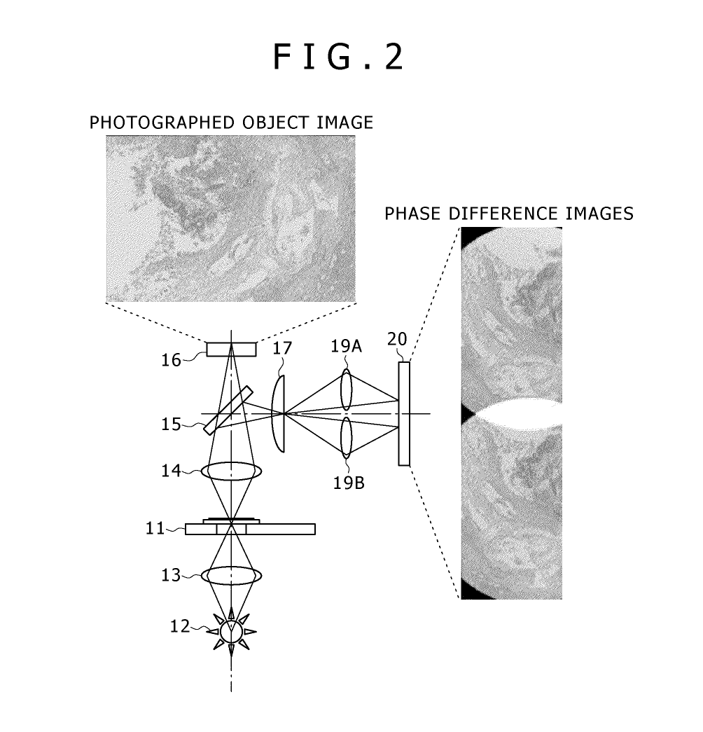

Pictures of the bright field image formed on the image pickup element 16 and the phase difference images formed on the image pickup element 20 are shown in FIG. 2. As is clear from FIG. 2, the subject image appearing in the objective lens 14 is formed on the image pickup surface of the image pickup element 16, and is meanwhile formed as phase difference images on the image pickup surface of the image pickup element 20 by the separator lenses 19A and 19B.

The image pickup control section 33 sets a parameter corresponding to the bright field mode or the dark field mode in the image pickup element 16, and obtains the data of the subject image formed on the image pickup surface of the image pickup element 16. This parameter is for example timing of starting exposure and timing of ending the exposure.

The image pickup control section 34 sets a parameter corresponding to the bright field mode or the dark field mode in the image pickup element 20, and obtains the data of the phase difference images formed on the image pickup surface of the image pickup element 20. This parameter is for example timing of starting exposure and timing of ending the exposure.

The stage driving control section 31, the illumination control section 32, and the image pickup control sections 33 and 34 are connected with a control section 30 for performing integrated control of the whole of the microscope 1 as a control system at a higher level than the control sections 31 to 34 (which control section 30 will hereinafter be referred to also as an integrated control section) via a data communication channel.

This integrated control section 30 is a computer including a CPU, a ROM, a RAM, an arithmetic circuit, an interface, and the like. The interface is detachably connected with a peripheral device such as an operating input section, a display section, a storage medium or the like.

The integrated control section 30 waits for a start instruction to start the bright field mode or the dark field mode. When receiving the start instruction, the integrated control section 30 issues a command to start control in the mode corresponding to the start instruction to the stage driving control section 31, the illumination control section 32, the image pickup control section 33, and the image pickup control section 34.

Then, each time the allocation of a part of the tissue section TS disposed in the preparation PRT to the condensed light part where light is condensed by the condenser lens 13 is changed, the integrated control section 30 obtains the data of a magnified image in the part of the tissue section TS, which data is output from the image pickup element 16, and stores the data on a storage medium.

In addition, the integrated control section 30 waits for a display instruction. When receiving the display instruction, the integrated control section 30 reads data corresponding to a magnified image specified by the display instruction from the storage medium, and supplies the data to a source that sent the display instruction.

Thus, the microscope 1 stores the tissue section TS in the preparation PRT as images in a microscopically examined state, and can thereby store information on the tissue section TS for a long period of time without degrading states of fixture, staining and the like as compared with a case of storing the preparation PRT itself.

### 1-2. Preparation Stage Driving Constitution

The preparation stage 11 in the microscope 1 is configured so as to be able to move in a direction orthogonal to a direction parallel to the preparation disposition surface and change the tilt angle of the preparation disposition surface.

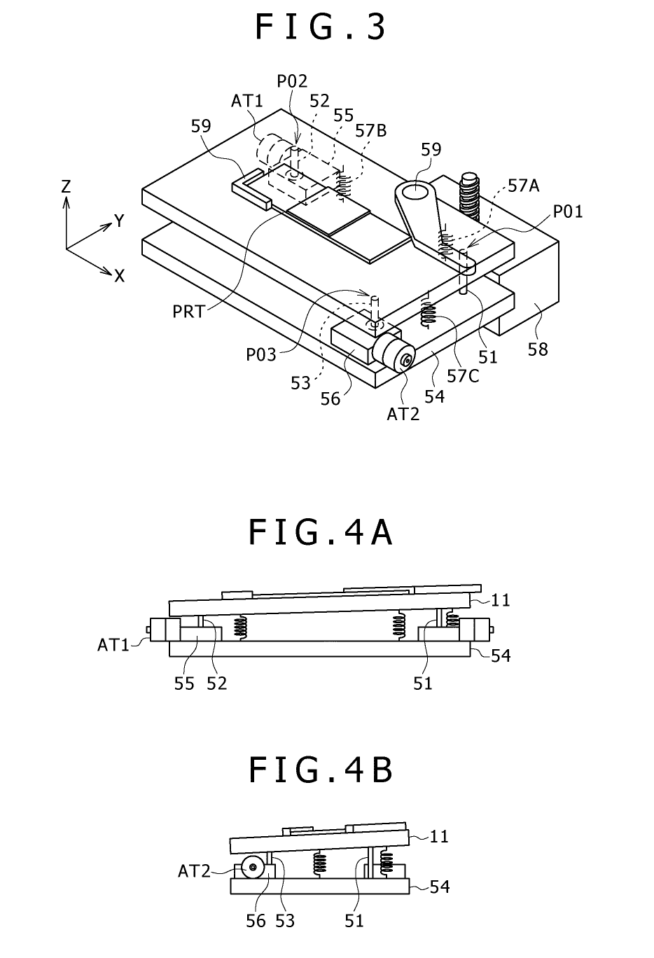

The driving constitution of the preparation stage 11 is illustrated in FIG. 3. The preparation stage 11 illustrated in FIG. 3 is supported at three points by bar-shaped supporting members 51, 52, and 53 disposed on an opposite surface (back surface) from the preparation disposition surface.

One end of the supporting member 51 is in point contact with a position PO1 on a diagonal line of the back surface of the preparation stage 11 and in the vicinity of a corner set as a reference. Another end of the supporting member 51 is fixed to a stage 54 serving as a supporting base (which stage will hereinafter be referred to also as a base stage).

One end of the supporting member 52 is in point contact with a position PO2 where a diagonal line of the back surface of the preparation stage 11 intersects an imaginary line that passes through the point in contact with one end of the supporting member 51 and which is parallel to a long side of the preparation stage 11. Another end of the supporting member 52 is coupled to a mechanism 55 for extending and contracting the supporting member 52 in a direction orthogonal to the preparation disposition surface (which mechanism will hereinafter be referred to also as a supporting member extending and contracting mechanism) according to a direction of rotation of a shaft rotating with an actuator AT1 as a driving source.

One end of the supporting member 53 is in point contact with a position PO3 where the diagonal line of the back surface of the preparation stage 11 intersects an imaginary line that passes through the point in contact with one end of the supporting member 51 and which is parallel to a short side of the preparation stage 11. Another end of the supporting member 53 is coupled to a mechanism (supporting member extending and contracting mechanism) 56 for extending and contracting the supporting member 53 in the direction orthogonal to the preparation disposition surface according to a direction of rotation of a shaft rotating with an actuator AT2 as a driving source.

The length of the supporting members 52 and 53 (length of a straight line connecting one end to the other end at a shortest distance) when the preparation disposition surface is in a horizontal state is set as an initial length in the supporting member extending and contracting mechanisms 55 and 56.

In addition, the present embodiment employs springs 57A, 57B, and 57C coupled to the preparation stage 11 and the base stage 54 as a force imparting mechanism for imparting a force acting in a direction of bringing the preparation stage 11 and the base stage 54 closer to each other.

When the supporting member 52 is extended or contracted with the initial length as a reference, as shown in FIG. 4A, the preparation disposition surface tilts to a short side direction (Y-direction) side with the supporting members 51 and 53 as supporting points. The angle of the tilt is increased as the length of the supporting member 52 extended or contracted by the supporting member extending and contracting mechanism 55 deviates more from the initial length.

When the supporting member 53 is extended or contracted with the initial length as a reference, as shown in FIG. 4B, the preparation disposition surface tilts to a long side direction (X-direction) side with the supporting members 51 and 52 as supporting points. The angle of the tilt is increased as the length of the supporting member 53 extended or contracted by the supporting member extending and contracting mechanism 56 deviates more from the initial length. Incidentally, in the tilt state shown in FIGS. 4A and 4B, the supporting member 52 is contracted with the initial length as a reference.

The preparation stage 11 shown in FIG. 3 can thus change the tilt angle of the preparation disposition surface.

In the present embodiment, at the position PO2 in point contact with one end of the supporting member 52, a groove for guiding the corresponding contact end in the short side direction (Y-direction) is formed, and at the position PO3 in point contact with one end of the supporting member 53, a groove for guiding the corresponding contact end in the long side direction (X-direction) is formed.

Thus, a shift in supporting position of the supporting members 51, 52, and 53 with respect to the preparation stage 11 is prevented. As a result, the tilt angle of the preparation disposition surface can be adjusted stably and accurately.

On the other hand, a base stage moving mechanism 58 is coupled to a predetermined position of the base stage 54. The base stage moving mechanism 58 has an X-axis and a Y-axis orthogonal to each other in a horizontal plane and a Z-axis in normal relation to the horizontal plane. The base stage moving mechanism 58 moves the base stage 54 in directions (the X-direction and the Y-direction) parallel to the preparation disposition surface and a direction (Z-direction) orthogonal to the preparation disposition surface separately according to directions of rotation of the axes.

Thus, the preparation stage 11 is moved in the same direction as a direction of movement of the base stage 54 moved by the base stage moving mechanism 58 via the supporting members 51, 52, and 53.

The preparation stage 11 shown in FIG. 3 is thus movable in the directions parallel to the preparation disposition surface and the direction orthogonal to the preparation disposition surface.

Incidentally, a holding section 59 for holding the preparation PRT in place is provided on the preparation disposition surface of the preparation stage 11 shown in FIG. 3, and a hole for guiding light applied from the light source 12 to the preparation PRT held by the holding section 59 is provided in the preparation stage 11.

A mode of arrangement of the light source 12 and the condenser lens 13 (FIG. 1) with respect to the preparation stage 11 shown in FIG. 3 is a matter of design, and various modes can be selected. For example, there is a mode in which both of the light source 12 and the condenser lens 13 are disposed between the preparation stage 11 and the base stage 54 or below the base stage 54. However, when the light source 12 is disposed below the base stage 54, the base stage 54 needs to have a hole for guiding the light applied from the light source 12.

As another example, there is a mode in which a reflecting mirror is disposed between the preparation stage 11 and the base stage 54, and the light source 12 and the condenser lens 13 are disposed in other than a space between the stages. In this mode, the light applied from the light source 12 is guided from a side of the base stage 54 to the preparation PRT via the reflecting mirror.

### 1-3. Functional Constitution of Stage Control Section

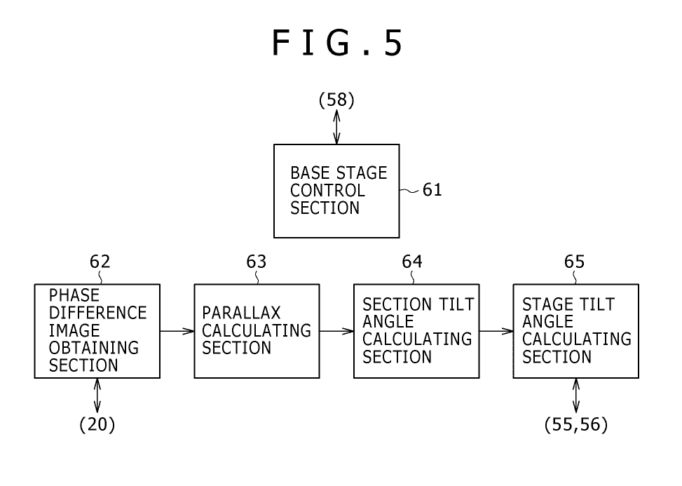

Next, FIG. 5 shows a functional configuration of the stage driving control section 31 (FIG. 1) for controlling the supporting member extending and contracting mechanisms 55 and 56 and the base stage moving mechanism 58. As shown in FIG. 5, the stage driving control section 31 functions as a base stage control section 61, a phase difference image obtaining section 62, a parallax calculating section 63, a section tilt angle calculating section 64, and a stage tilt angle adjusting section 65 according to a tilt angle adjusting process program.

The base stage control section 61 moves the base stage 54 in the X-direction or the Y-direction as appropriate by controlling the base stage moving mechanism 58, and thereby allocates the preparation PRT or the tissue section TS on the preparation to the condensed light part where light is condensed by the condenser lens 13.

Each time a part of the tissue section TS on the preparation which part is allocated to the condensed light part where light is condensed by the condenser lens 13 is changed, the phase difference image obtaining section 62 obtains the data of phase difference images in the corresponding section part from the image pickup element 20.

The parallax calculating section 63 calculates a distance between each pixel of one image to be set as a standard (which image will hereinafter be referred to also as a standard image) of the phase difference images and a relative pixel of the other image (which image will hereinafter be referred to also as a reference image) (which distance will hereinafter be referred to also as a parallax).

Specifically, each pixel in the standard image is selected as a pixel as an object of interest (which pixel will hereinafter be referred to as a pixel of interest) in order. Then, each time a pixel of interest is selected, a pixel relative to the pixel of interest is detected from the reference image, and a parallax (distance) between the pixel and the pixel of interest is calculated.

Incidentally, as a method for detecting the relative pixel, a method is for example applied which detects a block having a highest degree of similarity to pixel values in a block of m pixels×n pixels with the pixel of interest as a center from the reference image by a normalized correlation method, for example, and sets the center of the detected block as the relative pixel.

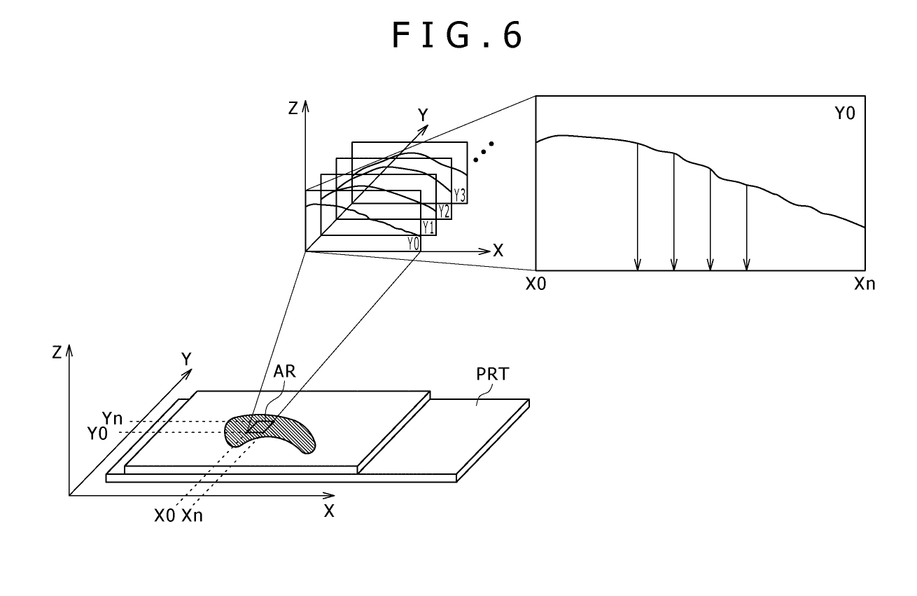

The smaller the parallax is, the nearer to the rear the focal point of the objective lens 14 is positioned, whereas the greater the relative distance is, the nearer to the front the focal point is positioned. Thus, as shown in FIG. 6, the parallax of each pixel in the phase difference images corresponds to information indicating a depression and projection state of a photographing range (region appearing on the image forming surface of the objective lens 14) AR in the tissue section in the preparation PRT.

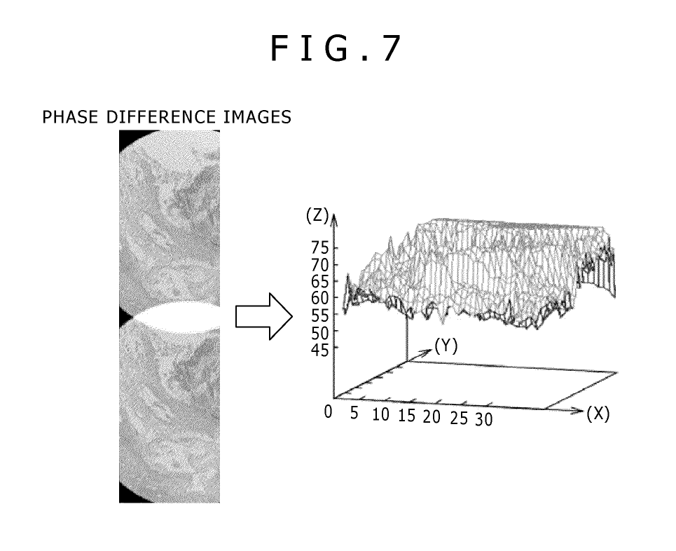

The relation of the parallax (distance) between the position of each pixel in the standard image and the pixel relative to the pixel in the standard image is shown as a graph in FIG. 7. A light part in the graph of FIG. 7 represents a top side, and a dark part in the graph of FIG. 7 represents an underside. FIG. 7 shows that the depression and projection state of parts of the tissue section projected on the image forming surface of the objective lens 14 is reflected. Incidentally, an end of a part of the tissue section shown as phase difference images in FIG. 7 is turned up.

When the parallax calculating section 63 has calculated parallaxes in the phase difference images of all parts assigned to the tissue section TS, the section tilt angle calculating section 64 calculates the tilt angles of the tissue section TS using the parallaxes.

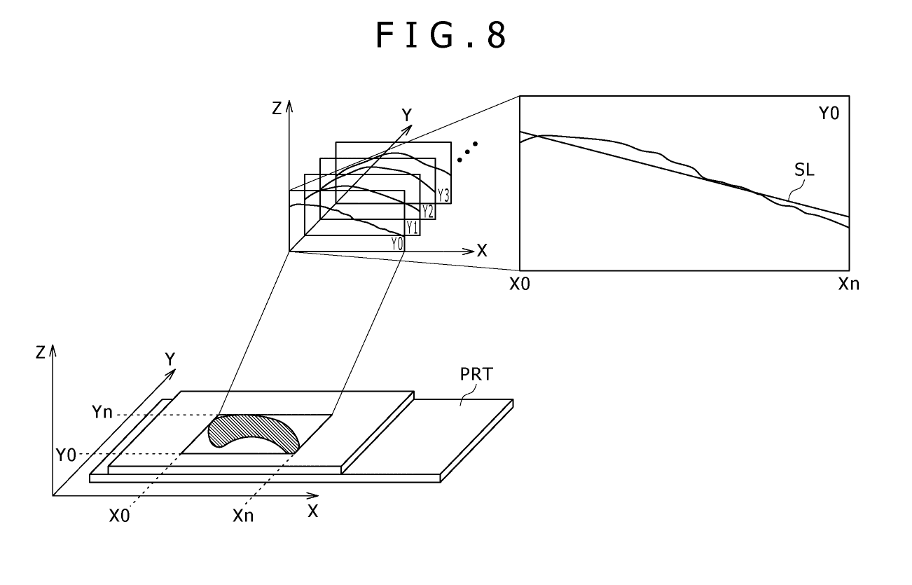

Specifically, for example, as shown in FIG. 8, a straight line SL most closely approximating the parallax distribution of each pixel in the X-Z direction is detected for each column Y0, Y1, . . . , Yn in the Y-direction by a method of least squares, for example. Then, a plane passing through the most of the straight lines of the respective Y-columns is determined by averaging the angles of the respective straight lines with respect to a horizontal plane, for example. That is, the tissue section TS is approximated to a plane closest to the depression and projection state as viewed from the X-Z direction. An angle formed between the plane and the horizontal plane is calculated as a tilt angle of the tissue section TS (which tilt angle will hereinafter be referred to also as an X-Z direction tilt angle).

Similarly, a straight line most closely approximating the parallax distribution of each pixel in the Y-Z direction is detected for each column in the X-direction. A plane passing through the most of the straight lines of the respective X-columns is detected. That is, the tissue section TS is approximated to a plane having a slope closest to the depression and projection state as viewed from the Y-Z direction. A slope angle formed between the plane and the horizontal plane and a direction thereof are calculated as a tilt angle of the tissue section TS (which tilt angle will hereinafter be referred to also as a Y-Z direction tilt angle).

When the plane approximating section 64 has calculated the X-Z direction tilt angle of the tissue section TS, the stage tilt angle adjusting section 65 adjusts the tilt angle of the preparation disposition surface so that the X-Z direction tilt angle with respect to the horizontal plane is 0°.

Specifically, an amount of extension or contraction (that is, an amount of height adjustment and a direction thereof) of the supporting member 52 corresponding to the X-Z direction tilt angle is determined. Then, a direction of rotation and an amount of rotation of the actuator AT1 in the supporting member extending and contracting mechanism 55, the direction of rotation and the amount of rotation of the actuator AT1 corresponding to the amount of extension or contraction of the supporting member 52, is set in the supporting member extending and contracting mechanism 55.

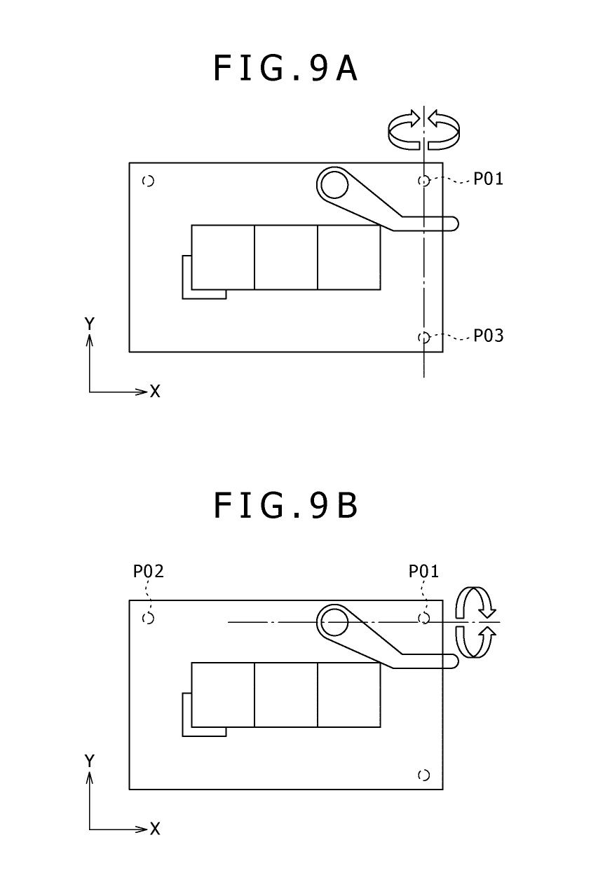

As a result, as shown in FIG. 9A, the tilt angle on the short side direction (Y-direction) side of the preparation disposition surface is adjusted with the contact points PO1 and PO3 of the supporting members 51 and 53 as supporting points, so that the tissue section TS as viewed from the X-Z direction is in a substantially horizontal state even though the tissue section TS has the depression and projection state. Even if the tissue section TS is tilted on the slide, the tissue section TS is set in a substantially horizontal state.

When the plane approximating section 64 has calculated the Y-Z direction tilt angle of the tissue section TS, on the other hand, the stage tilt angle adjusting section 65 adjusts the tilt angle of the preparation disposition surface so that the Y-Z direction tilt angle with respect to the horizontal plane is 0°.

Specifically, as in the case of the X-Z direction plane, an amount of extension or contraction of the supporting member 53 corresponding to the Y-Z direction tilt angle is determined. Then, a direction of rotation and an amount of rotation of the actuator AT2 in the supporting member extending and contracting mechanism 56, the direction of rotation and the amount of rotation of the actuator AT2 corresponding to the amount of extension or contraction of the supporting member 53, is set in the supporting member extending and contracting mechanism 56.

As a result, as shown in FIG. 9B, the tilt angle on the long side direction (X-direction) side of the preparation disposition surface is adjusted with the contact points PO1 and PO2 of the supporting members 51 and 52 as supporting points, so that the tissue section TS as viewed from the Y-Z direction is in a substantially horizontal state even though the tissue section TS has the depression and projection state.

Incidentally, the stage tilt angle adjusting section 65 adjusts the tilt angle on the short side direction (Y-direction) side of the preparation disposition surface after adjusting the tilt angle on the long side direction (X-direction) of the preparation disposition surface.

A tilt angle on a direction side whose adjustment was completed first may be changed by a minute amount when a tilt angle on a direction side as an object of subsequent adjustment is being adjusted. Thus, as compared with a case of adjusting the tilt angle on the short side direction (Y-direction) side first, adjusting the tilt angle on the long side direction (X-direction) side first can reduce an amount of change in the tilt angle whose adjustment was completed first due to the adjustment of the object of subsequent adjustment.

### 1-4. Tilt Angle Adjusting Process Procedure

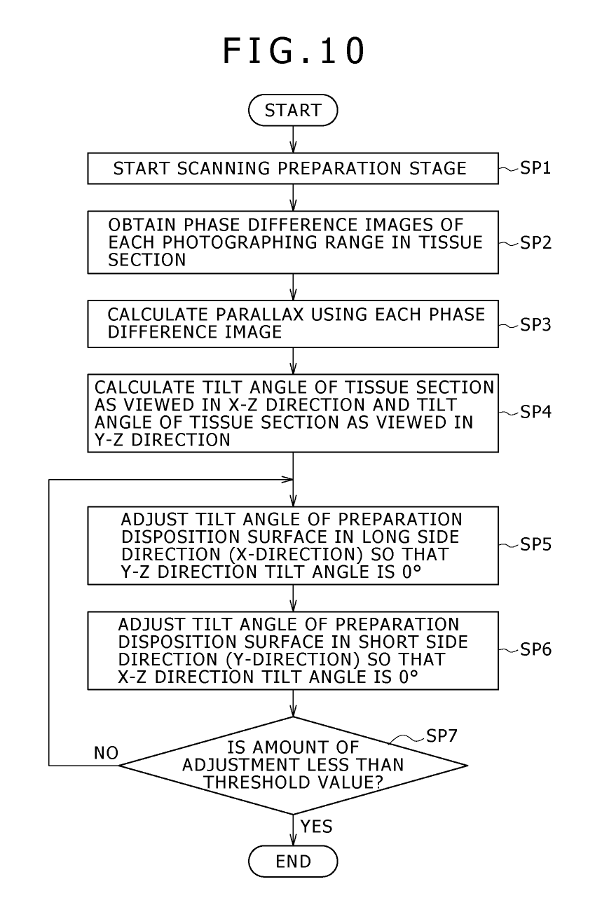

A tilt angle adjusting process procedure in the stage driving control section 31 will next be described with reference to a flowchart of FIG. 10.

When a command to start control is issued to the stage driving control section 31, the stage driving control section 31 starts the tilt angle adjusting process procedure, and proceeds to first step SP1. The stage driving control section 31 in first step SP1 starts scanning the preparation stage 11 supported on the base stage 54 via the supporting members 51 to 53 by controlling the base stage moving mechanism 58. The stage driving control section 31 then proceeds to second step SP2.

The stage driving control section 31 in second step SP2 obtains phase difference images of all parts of the tissue section TS allocated to the photographing range AR (FIG. 5). The stage driving control section 31 then proceeds to third step SP3.

The stage driving control section 31 in third step SP3 calculates a parallax in the phase difference image of each part. The stage driving control section 31 then proceeds to fourth step SP4.

The stage driving control section 31 in fourth step SP4 calculates the X-Z direction tilt angle and the Y-Z direction tilt angle of the tissue section TS with respect to the horizontal plane. The stage driving control section 31 then proceeds to fifth step SP5.

The stage driving control section 31 in fifth step SP5 adjusts the tilt angle in the long side direction (X-direction) of the preparation disposition surface so that the Y-Z direction tilt angle of the tissue section TS with respect to the horizontal plane is 0° (FIG. 8B). The stage driving control section 31 then proceeds to sixth step SP6.

The stage driving control section 31 in sixth step SP6 adjusts the tilt angle in the short side direction (Y-direction) of the preparation disposition surface so that the X-Z direction tilt angle of the tissue section TS with respect to the horizontal plane is 0° (FIG. 8A). The stage driving control section 31 then proceeds to seventh step SP7.

The stage driving control section 31 in seventh step SP7 determines whether amounts of adjustment of the tilt angles in the long side direction (X-direction) and the short side direction (Y-direction) of the preparation disposition surface are less than a threshold value. When the amounts of adjustment of the tilt angles in the long side direction (X-direction) and the short side direction (Y-direction) of the preparation disposition surface are not less than the threshold value, the stage driving control section 31 returns to fifth step SP5 to repeat the process in fifth step SP5 and sixth step SP6.

When the amounts of adjustment of the tilt angles in the long side direction (X-direction) and the short side direction (Y-direction) are less than the threshold value, on the other hand, the stage driving control section 31 ends the tilt angle adjusting process procedure.

Thus, when the amounts of adjustment of the tilt angles in the long side direction (X-direction) and the short side direction (Y-direction) of the preparation disposition surface are not less than the threshold value, the stage driving control section 31 readjusts the tilt angles until the amounts of adjustment of the tilt angles in the long side direction (X-direction) and the short side direction (Y-direction) of the preparation disposition surface become less than the threshold value. Hence, even when a tilt angle on a direction side whose adjustment was completed first is changed while a tilt angle on a direction side as an object of subsequent adjustment is being adjusted, the stage driving control section 31 can finely adjust the change to a certain amount.

### 1-5. Effects and Others

In the above constitution, the stage driving control section 31 obtains phase difference images of all parts of the tissue section TS allocated to the photographing range AR (FIG. 5), and calculates a parallax from each phase difference image (FIG. 6). Then, the stage driving control section 31 calculates the tilt angle of the tissue section TS with respect to the horizontal plane using the parallax calculated from each phase difference image, and adjusts the tilt angle of the preparation disposition surface such that the tilt angle of the tissue section TS is 0° with respect to the horizontal plane.

Thus, even when the tissue section TS is tilted on the slide, or even when the preparation PRT itself is tilted, the stage driving control section 31 can maintain the number of photographs taken in a direction of thickness of the tissue section TS as a photographing object at substantially the same level. As a result, the number of photographs taken in the direction of depth of the tissue section TS can be greatly reduced as compared with a case of photographing the tissue section TS that remains tilted.

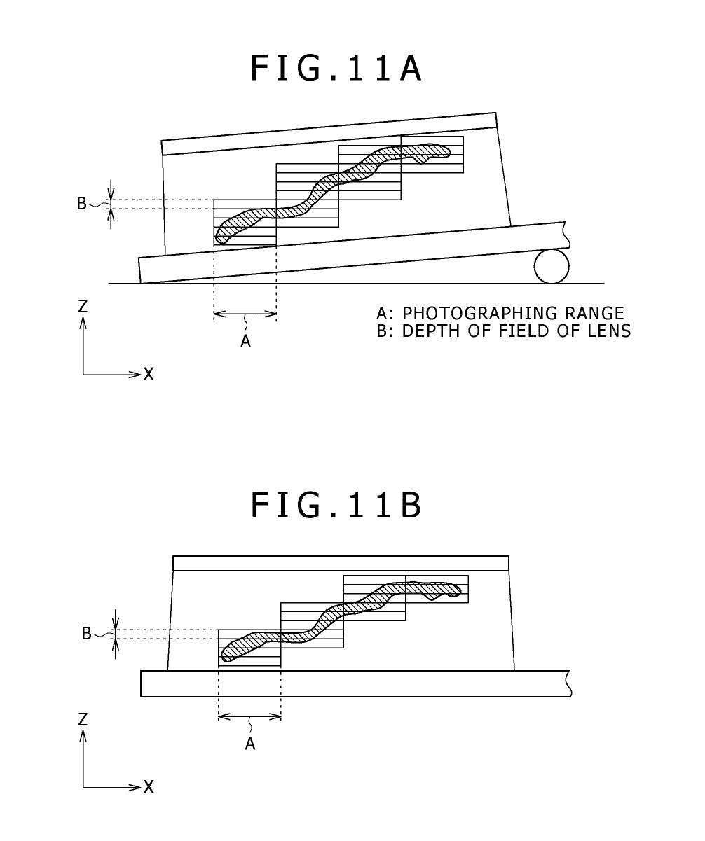

In general, when the preparation PRT is disposed on the preparation stage 11, foreign matter such as dust or the like is interposed between the preparation stage 11 and the preparation PRT. FIGS. 11A and 11B show that the number of photographs is increased in a case where dust is interposed (FIG. 11A) as compared with a case where the dust is not interposed (FIG. 11B).

For example, when the objective lens 14 has a magnification of 20× and the image pickup surface of the image pickup element 16 has dimensions of 4 cm×6 cm, the photographing region AR (FIG. 5) on the preparation PRT has dimensions of about 2 mm×3 mm. The slide in the preparation PRT generally has dimensions of 25 mm×75 mm.

When a dust of 100 μm is interposed in the vicinity of one short side of the preparation PRT under this condition, a slope of about 4 μm is added each time the preparation PRT is moved by 3 mm in the X-direction. In this case, when the depth of field of the objective lens 14 is 1 μm, the number of photographs is increased by four per unit of 3 mm. It should thus be understood that the number of photographs is greatly increased with the mere interposition of a dust of 100 μm.

Thus being able to reduce the number of photographs greatly by maintaining the number of photographs in the direction of thickness of the tissue section TS to be photographed at substantially the same level is very useful from a viewpoint of improving efficiency of obtainment of tissue section images.

In addition, a load in a process of searching for an in-focus position can be reduced by maintaining the number of photographs in the direction of thickness of the tissue section TS to be photographed at substantially the same level. Thus, the efficiency of obtainment of tissue section images can be further improved.

According to the above constitution, the microscope 1 capable of improving the efficiency of obtainment of tissue section images can be realized by making it possible to reduce the number of photographs greatly and reduce a load in a process of searching for an in-focus position.

### 2. Other Embodiments

In the foregoing embodiment, a tissue section TS is applied as a living body (organism) sample. However, living body samples are not limited to this embodiment. For example, smears, chromosomes and the like are applicable as living body samples. In addition, samples other than living body (organism) samples, such for example as semiconductor devices, may also be applied.

In addition, in the foregoing embodiment, phase difference images of the tissue section TS are obtained from the image pickup element 20. However, a source from which phase difference images of the tissue section TS are obtained is not limited to the image pickup element 20. For example, phase difference images of the tissue section TS may be obtained from a storage medium connected to the integrated control section 30. In addition, phase difference images of the tissue section TS may be obtained from the outside of the microscope 1 via a wire or wireless communication medium such as a local area network, the Internet or the like.

In addition, in the foregoing embodiment, the directions of changing the tilt angles of the preparation disposition surface of the preparation stage 11 are the same as the X-direction and the Y-direction as in-plane moving directions of the preparation disposition surface. However, the directions of changing the tilt angles are not limited to the same directions as the moving directions of the preparation disposition surface, but may be different directions from the moving directions of the preparation disposition surface.

Incidentally, from a viewpoint of reducing a processing load in a process of calculating the tilt angles of the preparation disposition surface and the like, it is more desirable that the directions of changing the tilt angles be the same as the moving directions of the preparation disposition surface than a case where the directions of changing the tilt angles are different from the moving directions of the preparation disposition surface.

In addition, in the foregoing embodiments, the number of directions in which to change the tilt angles of the preparation disposition surface of the preparation stage 11 is two, that is, the X-direction and the Y-direction as in-plane moving directions of the preparation disposition surface. However, the number of directions in which to change the tilt angles is not limited to two.

For example, one of the X-direction and the Y-direction as in-plane moving directions of the preparation disposition surface may be set as direction in which to change the tilt angles of the preparation disposition surface of the preparation stage 11. Incidentally, it is preferable that the number of directions in which to change the tilt angles be one from a viewpoint of reducing a processing load in a process of calculating the tilt angles of the preparation disposition surface and the like. However, it is preferable that the number of directions in which to change the tilt angles be two from a viewpoint of improving the accuracy of adjustment of the tilt angles.

In addition, in the foregoing embodiment, the X-direction and the Y-direction as in-plane moving directions of the preparation disposition surface are in orthogonal relation to each other. However, the orthogonal relation of the in-plane moving directions is not an essential condition.

In addition, in the foregoing embodiment, the supporting members 51, 52, and 53 are disposed in a state of being orthogonal to the preparation disposition surface. However, the supporting members 51, 52, and 53 may be disposed in a state of being tilted with respect to the preparation disposition surface.

In addition, in the foregoing embodiment, the supporting members 51, 52, and 53 each have a bar shape. However, the shape of the supporting members 51, 52, and 53 is not limited to a bar shape. In addition, while the supporting members 51, 52, and 53 generally have the same shape, the supporting members 51, 52, and 53 may have respective shapes different from each other.

Incidentally, when the supporting members 51, 52, and 53 having a large cross-sectional area are used, it suffices to form a taper at one end of the supporting members 51, 52, and 53 from a tip to another terminal thereof. Then, the preparation stage 11 can be supported at three points more stably.

In addition, in the foregoing embodiment, the positions of the contact points of the supporting members 51, 52, and 53 are the positions PO1, PO2, and PO3 in the vicinity of stage corners. However, the positions of the contact points are not limited to the positions PO1, PO2, and PO3. Various positions other than the arrangement positions such that each contact point is on a straight line can be set as the contact points of the supporting members 51, 52, and 53.

In addition, in the foregoing embodiment, a constitution in which the tilt angles of the preparation disposition surface of the preparation stage 11 can be changed in both of the X-direction and the Y-direction as moving directions of the preparation disposition surface independently is illustrated in FIG. 3 as a constitution in which the tilt angles of the preparation disposition surface of the preparation stage 11 can be changed. However, the constitution shown in FIG. 3 is a mere example.

For example, a constitution may be adopted in which the preparation stage 11 is provided to a shaft center in the Z-direction in the stage driving mechanism via a ball joint and the ball joint is driven to change the tilt angles of the preparation disposition surface. In short, various constitutions in which the tilt angles of the preparation disposition surface can be changed are widely applicable.

In addition, in the foregoing embodiment, phase difference images of all parts of the tissue section TS allocated to the photographing range AR (FIG. 5) are obtained. However, parts of the tissue section TS to be obtained as phase difference images are not limited to all the parts of the tissue section TS.

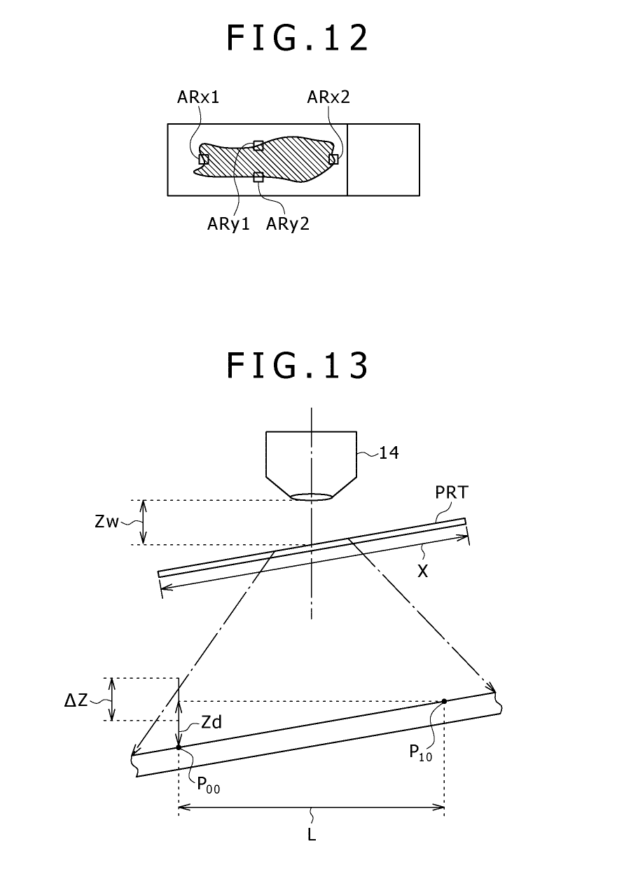

For example, as shown in FIG. 12, phase difference images of two regions ARx1 and ARx2 as ends in the long side direction of the tissue section TS and two regions ARy1 and ARy2 as ends in the short side direction of the tissue section TS may be obtained. In addition, a region having a barycenter of the tissue section TS may be added to these parts. In short, it suffices for the regions to be a part of the tissue section TS.

However, when one of the X-direction and the Y-direction as in-plane moving directions of the preparation disposition surface is set as direction in which to change the tilt angles of the preparation disposition surface, at least two regions in the one direction are necessary. When both of the X-direction and the Y-direction as in-plane moving directions of the preparation disposition surface is set as directions in which to change the tilt angles of the preparation disposition surface, at least four regions, that is, two regions in the X-direction and two regions in the Y-direction, or at least three regions, that is, a region to be set as a reference, one region at a distance from the reference region in the X-direction, and one region at a distance from the reference region in the Y-direction are necessary.

When parts of the tissue section TS to be obtained as phase difference images are thus limited, a time to obtain the phase difference images can be greatly shortened as compared with a case of obtaining phase difference images of all the parts of the tissue section TS.

In addition, in the foregoing embodiment, a straight line most closely approximating the parallax distribution of each pixel in the X-Z direction (Y-Z direction) is detected for each column, and an angle formed between a plane passing through the most of the straight lines of the respective Y-columns (X-columns) and the horizontal plane is calculated as a tilt angle of the tissue section TS. However, a method of calculating the tilt angle of the tissue section TS is not limited to this.

For example, in the case of FIG. 12, the X-Z direction tilt angle of the tissue section TS is approximated by a ratio of a difference between the X-positions of the regions ARx1 and ARx2 in the long side direction to a difference between a maximum value and a minimum value of parallaxes in the regions ARx1 and ARx2. Therefore, the ratio can be set as the X-Z direction tilt angle of the tissue section TS. On the other hand, the Y-Z direction tilt angle of the tissue section TS is approximated by a ratio of a difference between the y-positions of the regions ARy1 and ARy2 in the short side direction to a difference between a maximum value and a minimum value of parallaxes in the regions ARy1 and ARy2. Therefore, the ratio can be set as the Y-Z direction tilt angle of the tissue section TS.

In this case, the number of photographs can be greatly reduced as compared with a case of photographing the tissue section TS that remains in a tilted state. In addition to this, because a processing load can be greatly reduced as compared with a case of calculating the tilt angles of the tissue section TS using phase difference images of all parts of the tissue section TS allocated to the photographing range AR (FIG. 5), thus being able to reduce the number of photographs greatly is very useful from a viewpoint of improving efficiency of obtainment of tissue section images.

As another example, the tilt angles of the tissue section TS can be calculated by applying a search method employed in autofocusing. In short, as a method for calculating the tilt angles of the tissue section TS using parallaxes of all or a part of phase difference images of the tissue section TS, methods other than the above illustrated methods can be widely applied as long as the methods calculate the tilt angles of the tissue section TS reflecting the depression and projection state (parallaxes) of the tissue section TS.

Incidentally, while the tilt angles of the preparation disposition surface are adjusted so that the tilt angles (the X-Z direction tilt angle and the Y-Z direction tilt angle) of the tissue section TS are 0° with respect to the horizontal plane, this is a case where a state in which the preparation disposition surface is horizontal is set as a reference, for example.

When a state other than the state in which the preparation disposition surface is horizontal is set as a reference, for example, an adjusting method is different from that of the foregoing embodiment. However, it suffices to make adjustment so as to maintain the number of photographs in the direction of thickness of the tissue section TS to be photographed at substantially the same level.

In short, it suffices to adjust the preparation disposition surface on the basis of the tilt angles (the X-Z direction tilt angle and the Y-Z direction tilt angle) of the tissue section TS so that a tilt within an angle of view of a photographed image is minimized or so that the preparation disposition surface is orthogonal to the optical axis LX (FIG. 1) of the objective lens 14.

In addition, in the foregoing embodiment, the preparation disposition surface is typically adjusted when there is a tilt angle with respect to the preparation disposition surface.

In general, as shown in FIG. 13, an error ΔZ ([mm]) caused by variations in the preparation stage 11, accuracy of movement, and the like (which error will hereinafter be referred to as a stage error) is added to an amount of movement Zd ([mm]) of the preparation stage 11 to be moved in the Z-direction.

Due to this stage error ΔZ, adjusting the preparation disposition surface so that a tilt within an angle of view of a photographed image is minimized may instead invite an adverse effect of allowing the preparation PRT to strike against the objective lens 14 or an adverse effect of causing section parts to exceed the depth of field of the objective lens 14.

In addition, a distance Zw ([mm]) between the objective lens 14 and the preparation PRT on the optical axis (which distance will hereinafter be referred to also as a working distance) is shortened as the magnification (NA) of the objective lens 14 is heightened. That is, the probability of inviting the above-described adverse effect is increased as the magnification (NA) of the objective lens 14 is heightened.

Thus, defining a condition for not adjusting the preparation disposition surface even when there is a tilt angle with respect to the horizontal plane is useful from a viewpoint of reducing the above-described adverse effect.

Specifically, a threshold value for determining whether to adjust the preparation disposition surface or not is set for an amount of extension or contraction (amount of movement in the Z-direction) of the supporting member 52 or the supporting member 53, which amount of extension or contraction (amount of movement in the Z-direction) of the supporting member 52 or the supporting member 53 is calculated by the stage tilt angle adjusting section 65.

This threshold value is the depth of field of the objective lens 14. This is because the photographing of the tissue section TS is not affected substantially when the amount Zd of movement to be made in the Z-direction is within the range of the depth of field.

When the threshold value is set, fifth step SP5 and sixth step SP6 are changed in the tilt angle adjusting process procedure shown in FIG. 10 described above. Specifically, the stage driving control section 31 (stage tilt angle adjusting section 65) in fifth step SP5 determines an amount of extension or contraction of the supporting member 53 corresponding to the Y-Z direction tilt angle calculated in fourth step SP4, and compares the amount of extension or contraction with the set threshold value.

When the amount of extension or contraction is smaller than the threshold value, the stage driving control section 31 determines that the preparation disposition surface is not to be adjusted, and proceeds to sixth step SP6 without adjusting the tilt angle in the long side direction (X-direction) of the preparation disposition surface.

When the amount of extension or contraction is equal to or larger than the threshold value, on the other hand, the stage driving control section 31 adjusts the tilt angle in the long side direction (X-direction) of the preparation disposition surface (FIG. 8B) as described above, and proceeds to sixth step SP6.

In addition, the stage driving control section 31 in sixth step SP6 determines an amount of extension or contraction of the supporting member 52 corresponding to the X-Z direction tilt angle calculated in fourth step SP4, and compares the amount of extension or contraction with the set threshold value.

When the amount of extension or contraction is smaller than the threshold value, the stage driving control section 31 determines that the preparation disposition surface is not to be adjusted, and proceeds to seventh step SP7 without adjusting the tilt angle in the short side direction (Y-direction) of the preparation disposition surface.

When the amount of extension or contraction is equal to or larger than the threshold value, on the other hand, the stage driving control section 31 adjusts the tilt angle in the short side direction (Y-direction) of the preparation disposition surface (FIG. 8A) as described above, and proceeds to seventh step SP7.

Thus, the probability of inviting the above-described adverse effect is reduced because the photographing of the tissue section TS is not affected substantially even when no adjustment is made while there is a tilt angle with respect to the preparation disposition surface. Incidentally, the probability of inviting the above-described adverse effect is further reduced when the threshold value for the amount Zd of movement in the Z-direction (amount of extension or contraction of the supporting member 52 or the supporting member 53) is set so as to be lowered as the magnification of the objective lens 14 is heightened.

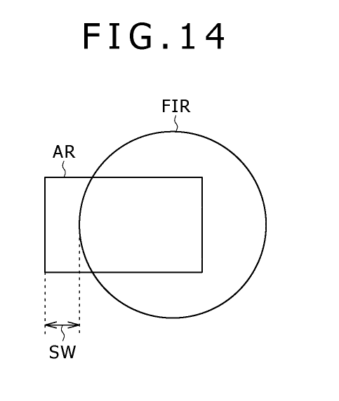

When parts of the tissue section TS to be obtained as phase difference images are limited as shown in FIG. 12, the range of a field of view of the phase difference images is reduced as the magnification of the objective lens 14 is heightened. Thus, as shown in FIG. 14, a shift width SW by which a field of view FIR of the objective lens 14 is shifted from the image pickup range AR of the image pickup element 20 is increased and therefore accuracy of calculation of the tilt angles tends to be decreased as the magnification of the objective lens 14 is heightened.

In addition, as shown in FIG. 13, the smaller the tissue section TS disposed in the preparation PRT is, the larger a difference between a tilt angle for a shortest distance L ([mm]) between the central position P₀₀ of the region ARx1 (or ARy1) and the central position P₁₀ of the region ARx2 (or ARy2) and a tilt angle for the entire width X ([mm]) in the long side direction (short side direction) of the preparation PRT tends to be.

Thus, when parts of the tissue section TS to be obtained as phase difference images are limited, merely setting a threshold value for an amount of extension or contraction of the supporting member 52 or the supporting member 53 which amount of extension or contraction of the supporting member 52 or the supporting member 53 is calculated by the stage tilt angle adjusting section 65 does not necessarily reduce the probability of inviting the above-described adverse effect.

Therefore, when parts of the tissue section TS to be obtained as phase difference images are limited, it is useful to define a condition for preventing the above-described adverse effect.

Specifically, letting an allowable amount of shift width SW (which allowable amount will hereinafter be referred to as a field of view range allowable amount) be A ([mm]) and a maximum value assumable as the stage error ΔZ be B ([mm]), the region ARx1 and the region ARx2 (FIG. 12) are determined so as to satisfy the following expressions:

B/(L×X)<Zw

B/(L×X)<A (1)

That is, the region ARx1 and the region ARx2 are determined by a relation such that the shortest distance L between the central positions P₀₀ and P₁₀ is increased with respect to a value obtained by dividing the stage error ΔZ by the stage length (width length in the long side direction or the short side direction) of the preparation PRT according to the magnification of the objective lens 14.

Incidentally, parameters other than “L” in Expression (1) are for example stored in a storage section 27 or the like. Incidentally, the working distance Zw and the field of view range allowable amount A are each stored in the storage section 27 or the like in association with the magnification of the objective lens 14.

When the region ARx1 and the region ARx2 are determined by using Expression (1), a new step to be performed in a stage preceding first step SP1 is added to the tilt angle adjusting process procedure shown in FIG. 10 described above.

Specifically, before preceding to first step SP1, the stage driving control section 31 (stage tilt angle adjusting section 65) arbitrarily determines each of the region ARx1 and the region ARx2 and the region ARy1 and the region ARy2 as a candidate.

The stage driving control section 31 also obtains a distance L between the central position P₀₀ of the region ARx1 determined as a candidate and the central position P₁₀ of the region ARx2 determined as a candidate and a distance L between the central position P₀₀ of the region ARy1 determined as a candidate and the central position P₁₀ of the region ARy2 determined as a candidate. In addition, the stage driving control section 31 obtains parameters other than these distances L from the storage section 27 or the like. The stage driving control section 31 thereafter substitutes the parameters and the distances L into Expression (1) and determines whether Expression (1) is satisfied.

When Expression (1) is not satisfied, the stage driving control section 31 determines new candidates again, and substitutes the distances L between the newly determined regions AR and the parameters obtained from the storage section 27 or the like into Expression (1).

When Expression (1) is satisfied, on the other hand, the stage driving control section 31 proceeds to first step SP1. In this case, the stage driving control section 31 scans the preparation stage 11 so as to assign the region ARx1 and the region ARx2 and the region ARy1 and the region ARy2 determined as candidates to the image pickup range AR (FIG. 5). The stage driving control section 31 then proceeds to second step SP2 to obtain phase difference images of the region AR.

Thus defining Expression (1) reduces the probability of parts of the tissue section TS to be obtained as phase difference images inviting the above-described adverse effect.

In addition, in the foregoing embodiment, the two separator lenses 19A and 19B are used. However, the number of separator lenses 19 is not limited to the embodiment. A plurality of separator lenses 19 can be used with a pair of separator lenses 19A and 19B as a unit (set). Incidentally, in this case, apertures corresponding to each set of separator lenses 19 need to be provided in the diaphragm mask 18.

In the foregoing embodiment, phase difference images are formed by the separator lenses 19A and 19B. However, a method for forming phase difference images is not necessarily limited to the embodiment, but another known method may be adopted.

In addition, the foregoing embodiment is applied to the microscope 1. However, the device is also applicable to various devices having a stage on which a sample is disposed.

The present embodiment is applicable in the biotechnology industry for gene testing, creation of medicines, patient follow-up or the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A stage control device comprising:
obtaining means for obtaining a set of images as different visual points in all or a part of a sample set as a photographing object;
distance calculating means for calculating a distance between each pixel of one image to be set as a reference in said set of images and a relative pixel in the other image;
tilt angle calculating means for calculating a tilt angle of said sample using the distance calculated by said distance calculating means; and
adjusting means for adjusting a tilt angle of a stage surface on which said sample is disposed to minimize a tilt within an angle of view of a photographed picture on a basis of the tilt angle of said sample.

2. The stage control device according to claim 1,
wherein when an amount of adjustment of the tilt angle of the stage surface on which said sample is disposed is equal to or larger than a threshold value, said adjusting means readjusts the tilt angle.

3. The stage control device according to claim 1,
wherein said tilt angle calculating means calculates both a tilt angle in an X-Z direction of said sample and a tilt angle in a Y-Z direction of said sample, and
said adjusting means adjusts a tilt angle in a short side direction of the stage surface on which said sample is disposed so as to minimize the tilt within the angle of view of the photographed picture on a basis of the tilt angle in said X-Z direction, and adjusts a tilt angle in a long side direction of the stage surface on which said sample is disposed so as to minimize the tilt within the angle of view of the photographed picture on a basis of the tilt angle in said Y-Z direction.

4. The stage control device according to claim 3,
wherein said adjusting means starts to adjust the tilt angle in the short side direction of the stage surface on which said sample is disposed after completing adjusting the tilt angle in the long side direction of the stage surface.

5. A stage control method comprising:
obtaining a set of images as different visual points in all or a part of a sample set as a photographing object;
calculating a distance between each pixel of one image to be set as a reference in said set of images and a relative pixel in the other image;
calculating a tilt angle of said sample using the distance calculated in said distance calculating step; and
adjusting a tilt angle of a stage surface on which said sample is disposed so as to minimize a tilt within an angle of view of a photographed picture on a basis of the tilt angle of said sample.

6. A stage control computer program product stored on a computer-readable medium including executable instructions that when executed by a processor perform steps for:
obtaining a set of images as different visual points in all or a part of a sample set as a photographing object;
calculating a distance between each pixel of one image to be set as a reference in said set of images and a relative pixel in the other image;
calculating a tilt angle of said sample using the calculated distance; and
adjusting a tilt angle of a stage surface on which said sample is disposed so as to minimize a tilt within an angle of view of a photographed picture on a basis of the tilt angle of said sample.

7. A microscope comprising:
a stage having a surface on which a sample is disposed, the stage being movable in a direction parallel to the surface and a direction orthogonal to the surface, and the stage being capable of changing a tilt angle of the surface;
an objective lens for forming an image of a part of the sample disposed on said surface;
an optical system for forming a set of images as different visual points using the image formed in said objective lens;
distance calculating means for calculating a distance between each pixel of one image to be set as a reference in the set of images formed by said optical system and a relative pixel in the other image;
tilt angle calculating means for calculating a tilt angle of said sample using the distance calculated by said distance calculating means; and
adjusting means for adjusting a tilt angle of the stage surface on which said sample is disposed so as to minimize a tilt within an angle of view of a photographed picture on a basis of the tilt angle of said sample.

8. A stage control device comprising:
an obtaining section obtaining a set of images as different visual points in all or a part of a sample set as a photographing object;
a distance calculating section calculating a distance between each pixel of one image to be set as a reference in said set of images and a relative pixel in the other image;
a tilt angle calculating section calculating a tilt angle of said sample using the distance calculated by said distance calculating section; and
an adjusting section adjusting a tilt angle of a stage surface on which said sample is disposed so as to minimize a tilt within an angle of view of a photographed picture on a basis of the tilt angle of said sample.
